(19) United States
(12) Patent Application Publication
(10) Pub. No.: US 2016/0017260 A1
(43) Pub. Date: Jan. 21, 2016

(54) Automatic Dishwashing Detergent Compositions Comprising Ethercarboxylic Acids Or Their Salts, Which Are Free Of Nonionic Surfactants

(71) Applicant: CLARIANT INTERNATIONAL LTD, Muttenz (CH)

(72) Inventors: George Italo Pitombeira NUNES, Bad Soden (DE); Carsten COHRS, Frankfurt (DE)

(21) Appl. No.: 14/774,630

(22) PCT Filed: Mar. 8, 2014
(86) PCT No.: PCT/EP2014/000595

§ 371 Date: Sep. 10, 2015

Related U.S. Application Data
(63) Continuation of application No. 13/804,868, filed on Mar. 14, 2013.
Application No. 13/804,868 is a continuation of application No. 13/912,929, filed on Jun. 7, 2013, now abandoned.

(51) Int. Cl. C11D 1/06; C11D 17/00; A47L 15/00; C11D 3/39

(52) U.S. Cl. CPC C11D 1/06; C11D 3/3932; C11D 3/3942; C11D 17/0091; A47L 15/00

(57) ABSTRACT

The present invention relates to automatic dishwashing detergent compositions comprising
a) one or more compounds of the formula (I)

RO—(CH₂CH₂O—)ₙCH₂—COOM (I),
wherein
R is a linear or branched saturated alkyl group comprising from 8 to 30 carbon atoms or a linear or branched unsaturated alkenyl group with one or more double bonds and comprising from 8 to 30 carbon atoms,
n is a number from 1 to 20, and
M is a counter ion,
b) one or more builder substances, and
c) one or more bleaching agents, wherein
   the automatic dishwashing detergent compositions contain no chloride ions or wherein the total amount of chloride ions in the automatic dishwashing detergent compositions is below 0.5% by weight, referring to the total composition, and which are characterized in that the automatic dishwashing detergent compositions are free of nonionic surfactants.

The present invention is in the field of automatic dishwashing detergent compositions which are free of nonionic surfactants and comprise specific ethercarboxylic acids or ethercarboxylic acid salts.

Automatic dishwashing, especially domestic dishwashing has undergone continuous changes and improvement as the format moves into the direction of all-in-one dosing systems like tabs, pouches and even dosing units, demanding new surfactant systems which are effective as rinse aids against spotting and filming while they are present through the whole washing cycle. In addition, environmental trends, like washing at lower temperatures and with less water, the reduction or even ban of phosphates like sodium tripolyphosphate (STPP) and the demand to use raw materials from renewable resources instead of petroleum based chemicals challenge the formulator in his choice of the surfactant system. On the other hand, the freedom to select suitable surfactants is limited by the unique requirement of very low foaming compositions, which is incompatible with most common surfactant systems typically used in other cleaning compositions, e.g. hand dishwashing liquids, where stable foam is seen as desirable.

It was an object of the present invention to provide automatic dishwashing detergent compositions which, besides a favorable cleaning performance, in particular also show a favorable anti-spotting behavior.

Surprisingly, it has now been found that this object is achieved with automatic dishwashing detergent compositions comprising

a) one or more compounds of the formula (I)

RO—(CH₂CH₂O—)ₙCH₂—COOM (I),
wherein
R is a linear or branched saturated alkyl group comprising from 8 to 30 carbon atoms or a linear or branched unsaturated alkenyl group with one or more double bonds and comprising from 8 to 30 carbon atoms,
n is a number from 1 to 20, and
M is a counter ion,
   b) one or more builder substances, and
   c) one or more bleaching agents, wherein
   the automatic dishwashing detergent compositions contain no chloride ions or wherein the total amount of chloride ions in the automatic dishwashing detergent compositions is below 0.5% by weight, referring to the total composition, and which are characterized in that the automatic dishwashing detergent compositions are free of nonionic surfactants.

The present invention therefore provides automatic dishwashing detergent compositions comprising

a) one or more compounds of the formula (I)

RO—(CH₂CH₂O—)ₙCH₂—COOM (I),
wherein
R is a linear or branched saturated alkyl group comprising from 8 to 30 carbon atoms or a linear or branched unsaturated alkenyl group with one or more double bonds and comprising from 8 to 30 carbon atoms,
n is a number from 1 to 20, and
M is a counter ion,
   b) one or more builder substances, and
   c) one or more bleaching agents, wherein
   the automatic dishwashing detergent compositions contain no chloride ions or wherein the total amount of chloride ions in the automatic dishwashing detergent compositions is below 0.5% by weight, referring to the total composition, and which are characterized in that the automatic dishwashing detergent compositions are free of nonionic surfactants.

In an alternative embodiment the present invention provides automatic dishwashing detergent compositions comprising

a) one or more compounds of the formula (I)

RO—(CH₂CH₂O—)ₙCH₂—COOM (I),
wherein
R is a linear or branched saturated alkyl group comprising from 8 to 30 carbon atoms or a linear or branched unsaturated alkenyl group with one or more double bonds and comprising from 8 to 30 carbon atoms,
n is a number from 1 to 20, and
M is a counter ion, and
   b) one or more builder substances,
   wherein the automatic dishwashing detergent compositions are free of nonionic surfactants.

In this alternative embodiment the presence of additional component c) and optional component d) and/or optional component e) is not necessarily mandatory.

Furthermore, in this alternative embodiment a low chloride ion content is not necessarily mandatory.

Due to the presence of the one or more surfactants of the formula (I) the inventive automatic dishwashing detergent compositions show a favorable anti-spotting behavior and possess a favorable cleaning performance. The surfactants of the formula (I) do not impart to major foaming and insofar the inventive compositions are furthermore low foaming. The surfactants of the formula (I) are biodegradable and are based—due to their alcohol component RO—on renewable primary products and insofar the inventive automatic dishwashing detergent compositions are also environment-friendly.

The inventive automatic dishwashing detergent compositions furthermore have the advantage that the one or more surfactants of the formula (I) contained therein reveal their advantageous properties and in particular provide a favorable anti-spotting behavior also in phosphate-free compositions. Compared with common low foaming non-ionic surfactants the one or more surfactants of the formula (I) often lead to an improved anti-spotting behavior.

The person skilled in the art knows which surfactants belong to the group of nonionic surfactants and which surfactants do not belong thereto. For example, alkyl alcohols or alkoxylated alkyl alcohols (such as ethoxylated alkyl alcohols) belong to the group of nonionic surfactants but surfactants bearing a carboxylic group —COOH do not belong to the group of nonionic surfactants (but to the group of anionic surfactants). The carboxylic group —COOH of the respective surfactant bearing it dissociates in water at 20° C. resulting in a surfactant bearing an anionic —COO⁻ group and protons H⁺. The degree of dissociation is e.g. dependent on the pH value of the environment of the surfactant bearing the carboxylic group.

U.S. Pat. No. 4,272,394 discloses automatic dishwashing detergents containing blends of low foaming nonionic surfactants, where the second surfactant has a relatively low cloud point.

WO 94/22800 describes low cloud point epoxy capped poly(oxyalkylated) alcohols and automatic dishwasher compositions containing them.

U.S. Pat. No. 6,593,287 discloses alkyl-capped nonionic surfactants and automatic dishwashing compositions containing them.

EP 1 757 676 describes the use of charged surfactants including ethercarboxylates, namely alkylethoxycarboxylates, alkylethoxysulfates with specific chainlengths and EO (ethyleneoxy —CH₂CH₂O—) levels, sulfobetaines, alkylpolyethoxysulfates, alkylpolyethoxycarboxylates and alkyl sulfates and sulfonates. However, it is mandatory that a low foaming nonionic, specifically a low cloud point surfactant with a cloud point below 30° C. in water, is present in the composition to prevent the foaming issues.

In the one or more compounds of the formula (I) the counter ion M preferably is selected from the group consisting of H⁺, Na⁺, K⁺, Mg²⁺/2, Ca²⁺/2, NH₄⁺, monoethanolammonium, diethanolammonium and triethanolammonium.

Particularly preferably, in the one or more compounds of formula (I) the counter ion M is selected from the group consisting of H⁺, Na⁺ and K+.

Examples for the alkyl and alkenyl groups R of the compounds of the formula (I) are e.g. the alkyl and alkenyl groups of the following alcohols R—OH: 1-octanol (capryl alcohol), 2-ethyl hexanol, 1-nonanol (pelargonic alcohol), 1-decanol (capric alcohol), 1-undecanol, 1-dodecanol (lauryl alcohol), 1-tridecanol, isotridecanol, 1-tetradecanol (myristyl alcohol), 1-pentadecanol, 1-hexadecanol (cetyl alcohol), cis-9-hexadecen-1-ol (palmitoleyl alcohol), 1-heptadecanol, 1-octadecanol (stearyl alcohol), cetearyl alcohol, 16-methylheptadecan-1-ol (isostearyl alcohol), 9E-octadecen-1-ol (elaidyl alcohol), cis-9-octadecen-1-ol (oleyl alcohol), mixture comprising oleyl alcohol and cetyl alcohol, 9Z,12Z-octadecadien-1-ol (linoleyl alcohol), 9E,12E-octadecadien-1-ol (elaidolinoleyl alcohol), 9Z, 12Z, 15Z-octadecatrien-1-ol (linolenyl alcohol), 9E, 12E,15E-octadecatrien-1-ol (elaidolinolenyl alcohol), 1-nonadecanol, 1-eicosanol (arachidyl alcohol), 1-heneicosanol, 1-docosanol (behenyl alcohol), cis-13-docosen-1-ol (erucyl alcohol), 1-tetracosanol (lignoceryl alcohol), 1-hexacosanol (ceryl alcohol), 1-octacosanol (montanyl alcohol) and 1-triacontanol (myricyl alcohol) or mixtures of the above.

The groups R of the compounds of the formula (I) can be derived from naturally occurring alcohols R—OH which usually comprise mixtures of different residues R. The groups R of the compounds of the formula (I) can also be derived from synthetically prepared alcohols R—OH such as oxo alcohols, e.g. oxo alcohol C₁₂₋₁₅.

In the one or more compounds of the formula (I) R preferably is a linear or branched saturated alkyl group comprising from 12 to 18 carbon atoms or a linear or branched unsaturated alkenyl group with one or more double bonds and comprising from 12 to 18 carbon atoms.

Particularly preferably, in the one or more compounds of the formula (I) R is a linear or branched saturated alkyl group comprising from 16 to 18 carbon atoms or a linear or branched unsaturated alkenyl group with one or more double bonds and comprising from 16 to 18 carbon atoms.

Preferably, in the one or more compounds of the formula (I) 50 wt.-% or more of the groups R are linear or branched unsaturated alkenyl groups with one or more double bonds.

Particularly preferably, in the one or more compounds of the formula (I) R is a linear group.

Even more preferred, in the one or more compounds of the formula (I) R is a mixture comprising an oleyl group and a cetyl group. Oleyl is a group derived from oleyl alcohol which is an octadecenol or cis-9-octadecen-1-ol, whereas cetyl is a group derived from cetyl alcohol a saturated fatty alcohol comprising 16 carbon atoms.

In the one or more compounds of the formula (I) n preferably is a number from 1 to 3.

Particularly preferably, in the one or more compounds of the formula (I) n is 2.

Most preferred compounds of formula (I) are mixtures of alkyloxydiethoxy-/alkenyloxydiethoxy carboxylic acid. A preferred group of these compounds belongs to the group of C₁₆-alkyl-C₁₈-alkenylethercarboxylic acids with 2 ethylene oxide units. Preferred compounds of this group are derived from C₁₆-C₁₈ fatty acid alcohols with 2 ethylene oxide units being covalently bound to acetic acid, wherein the alkyloxy component is derived from cetyl alcohol as main component and the alkenyloxy component is derived from oleyl alcohol as main component. A product comprising these compounds is available as Emulsogen® COL 020 from Clariant.

The compounds of formula (I) used in the automatic dishwashing detergent compositions of this invention contain no halides or low amounts of halides, especially of chlorides. Preferred are automatic dishwashing compositions have a chloride content between 0 and 0.1% by weight, preferably between 0 and 0.05% by weight, and most preferably between 0.001 and 0.05% by weight, referring to the total composition. The chloride content is determined via ion exchange chromatography using the following test procedure.

A sample of the automatic dishwashing detergent composition is introduced into a sample loop of known volume. A buffered aqueous solution as the mobile phase carries the sample from the loop onto a column that contains a stationary phase material. This is typically a resin or gel matrix consisting of polystyrene beads with covalently bonded ammonium functional groups. The target analytes (chloride anions) are retained on the stationary phase but can be eluted by increasing the concentration of a similarly charged species that will displace the analyte (chloride) ions from the stationary phase. In chloride exchange chromatography, the negatively charged analyte chloride is displaced by the addition of negatively charged bromide ions. The concentration of the chloride ions of interest is then be detected by UV/Visible light absorbance.

The inventive automatic dishwashing detergent compositions comprise the one or more compounds of the formula (I) preferably in amounts from 0.1 to 15 wt.-%, more preferably in amounts from 0.2 to 10 wt.-% and particularly preferably in amounts from 0.2 to 5 wt.-%, in each case based on the total weight of the inventive automatic dishwashing detergent composition.

The variable “n” in the one or more compounds of the formula (I) represents molar averages, i.e. the inventive automatic dishwashing detergent compositions may comprise several compounds of the formula (I) that differ in the ethoxylation degree.

The inventive automatic dishwashing detergent compositions may comprise more than one compound of the formula (I). In this case the inventive automatic dishwashing detergent compositions may e.g. comprise more than one compound of the formula (I) that differ in the group “R” and/or that differ in the ethoxylation 10 degree and/or that differ in the counter ion “M”.

The inventive automatic dishwashing detergent compositions comprise the one or more builder substances b) preferably in amounts from 5 to 90 wt.-% and more preferably in amounts from 5 to 80 wt.-%, in each case based on the total weight of the inventive automatic dishwashing detergent composition.

The builder substances b) as well as other ingredients usable in the inventive automatic dishwashing detergent compositions are e.g. described in US 2010/0160204 A1 and EP 1 757 676 A1.

Included among the builders b) are carbonates, hydrogencarbonates, organic builders, silicates, phosphates, phosphonates, methylglycinediacetic acid (MGDA), and alkali-metal hydroxides.

It is particularly preferred to use carbonate(s) and/or hydrogencarbonate(s), by preference alkali carbonate(s), particularly preferably sodium carbonate. These substances are preferably used in quantities from 2 to 50 wt.-%, by preference from 10 to 30 wt.-%, and in particular from 10 to 25 wt.-%, based on the total weight of the inventive automatic dishwashing detergent composition.

Organic builders b) include polycarboxylates/polycarboxylic acids, polymeric carboxylates, aspartic acid, polyacetals, and dextrins.

Usable organic builders b) include polycarboxylic acids, which can be used in the form of the free acid and/or its sodium salts, “polycarboxylic acids” being understood as those carboxylic acids that carry more than one acid function.

Examples are citric acid, adipic acid, succinic acid, glutaric acid, malic acid, tartaric acid, maleic acid, fumaric acid, sugar acids, aminocarboxylic acids, and nitrilotriacetic acid (NTA), as well as mixtures thereof. Free acids typically also have an acidifying component in addition to their builder effect, and thus also serve to establish a lower and milder pH for the inventive automatic dishwashing detergent compositions. Worthy of mention in this context are, in particular, citric acid, succinic acid, glutaric acid, adipic acid, gluconic acid, and any mixtures thereof.

Particularly preferred inventive automatic dishwashing detergent compositions contain citrate as one of their builders b). Inventive automatic dishwashing detergent compositions containing from 2 to 40 wt.-%, preferably from 5 to 30 wt.-%, and particularly preferably from 10 to 30 wt.-% citrate, based on the total weight of the inventive automatic dishwashing detergent composition, are preferred.

Polymeric carboxylates are also suitable as organic builders b). These are, for example, the alkali-metal salts of polyacrylic acid or of polymethacrylic acid, for example, those having a relative molecular weight from 500 to 70,000 g/mol.

Suitable polymeric carboxylates are, in particular, polyacrylates, preferably having a molecular weight from 2000 to 20,000 g/mol. Because of their superior solubility, short-chain polyacrylates having molar weights from 2000 to 10,000 g/mol, and particularly preferably from 3000 to 5000 g/mol, may in turn be preferred.

Also suitable are copolymeric carboxylates, in particular, those of acrylic acid with methacrylic acid, and acrylic acid or methacrylic acid with maleic acid. Copolymers of acrylic acid with maleic acid containing from 50 to 90 wt.-% acrylic acid and from 10 to 50 wt.-% maleic acid have proven particularly suitable. Their relative molecular weight, based on free acids, is preferably from 2000 to 70,000 g/mol, more preferably from 20,000 to 50,000 g/mol, and in particular from 30,000 to 40,000 g/mol.

In case the inventive automatic dishwashing detergent compositions comprise one or more (co)polymeric carboxylates, the amount of these (co)polymeric carboxylates in the inventive automatic dishwashing detergent compositions preferably is from 0.5 to 20 wt.-% and in particular from 3 to 10 wt.-%, based on the total weight of the inventive automatic dishwashing detergent composition.

Inventive automatic dishwashing detergent compositions may preferably contain, as a builder b), crystalline sheet-form sodium silicates of the general formula NaMSiₓO₂ₓ₊₁.yH₂O wherein M is sodium or hydrogen; x is a number from 1.9 to 22, by preference from 1.9 to 4, particularly preferred values for x being 2, 3, or 4; and y is a number from 0 to 33, by preference from 0 to 20.

Also usable are amorphous sodium silicates having a Na₂O:SiO₂ modulus from 1:2 to 1:3.3, preferably from 1:2 to 1:2.8, and in particular from 1:2 to 1:2.6, which by preference are dissolution-delayed and exhibit secondary washing properties.

In case the inventive automatic dishwashing detergent compositions comprise one or more silicates, the amount of these silicates in the inventive compositions preferably is from 5 to 30 wt.-% and more preferably from 10 to 25 wt.-%, based on the total weight of the inventive automatic dishwashing detergent composition.

Phosphates have proven to be effective builders in terms of cleaning performance. Among the many commercially obtainable phosphates, alkali-metal phosphates have the greatest significance in the washing- and cleaning-agent industry, particularly pentasodium or pentapotassium triphosphate (sodium or potassium tripolyphosphate).

“Alkali-metal phosphates” is the summary designation for the alkali-metal (particularly sodium and potassium) salts of the various phosphoric acids, in which context a distinction can be made between metaphosphoric acids (HPO₃)ₘ and orthophosphoric acid H₃PO₄, in addition to higher-molecular-weight representatives. Phosphates have a combination of advantages: they act as alkali carriers, prevent lime deposits on machine parts and contribute to cleaning performance.

Phosphates that are technically especially important are pentasodium triphosphate Na₅P₃O₁₀ (sodium tripolyphosphate) and the corresponding potassium salt pentapotassium triphosphate K₅P₃O₁₀ (potassium tripolyphosphate). Further preferred phosphates are the sodium potassium tripolyphosphates.

If phosphates are used in the inventive automatic dishwashing detergent compositions, preferred compositions contain phosphate(s), preferably alkali-metal phosphate(s), particularly preferably pentasodium or pentapotassium triphosphate (sodium or potassium tripolyphosphate) in quantities from 2 to 50 wt.-%, preferably from 2 to 30 wt.-%, more preferably from 3 to 25 wt.-%, and particularly preferably from 3 to 15 wt.-%, based in each case on the total weight of the inventive automatic dishwashing detergent composition.

As further builder(s) b), inventive automatic dishwashing detergent compositions can contain phosphonate(s). The weight proportion of phosphonate, based on the total weight of the inventive automatic dishwashing detergent composition, preferably is from 0.5 to 20 wt.-%, and more preferably from 1.0 to 10 wt.-%.

Complexing phosphonates include a number of different compounds such as 1-hydroxyethane-1,1-diphosphonic acid (HEDP) or diethylenetriaminepenta-(methylenephosphonic acid) (DTPMP). Hydroxyalkane- and aminoalkanephosphonates are particularly preferred. Among the hydroxyalkanephosphonates, 1-hydroxyethane-1,1-diphosphonate (HEDP) is of particular importance, preferably as a cobuilder. It is preferably used as a sodium salt, the disodium salt reacting neutrally and the tetrasodium salt in alkaline fashion (pH 9). Suitable aminoalkanephosphonates include ethylenediaminetetramethylenephosphonate (EDTMP), diethylenetriaminepentamethylenephosphonate (DTPMP), and their higher homologs. They are preferably used in the form of the neutrally reacting sodium salts (e.g. as a hexasodium salt of EDTMP or as a hepta- and octasodium salt of DTPMP). Of the class of the phosphonates, HEDP is preferred.

As an alternative to phosphonates, methylglycinediacetic acid (MGDA) can also be used in the inventive automatic dishwashing detergent compositions as a complexing agent.

In case the inventive automatic dishwashing detergent compositions comprise methylglycinediacetic acid (MGDA), the amount of this compound in the inventive compositions preferably is from 0.5 to 25 wt.-% and more preferably from 5 to 20 wt.-%, based on the total weight of the inventive automatic dishwashing detergent composition.

Inventive automatic detergent dishwashing compositions can contain as further builders b) alkali-metal hydroxides. These alkali carriers are used preferably only in small quantities, preferably in quantities of 10 wt.-% or less, more preferably 6 wt.-% or less, by preference 5 wt.-% or less, particularly preferably from 0.1 to 5 wt.-%, and in particular from 0.5 to 5 wt.-%, based on the total weight of the inventive automatic detergent dishwashing composition.

In a further preferred embodiment of the invention the inventive automatic dishwashing detergent compositions comprise one or more builder substances b) selected from the group consisting of carbonates, citrates and phosphates. In a particularly preferred embodiment of the invention the inventive automatic dishwashing detergent compositions comprise one or more builder substances b) selected from the group consisting of carbonates and citrates.

The inventive automatic detergent dishwashing compositions can contain the aforementioned builders b) both individually and as mixtures of two, three, four or more builders.

The inventive automatic dishwashing detergent compositions comprise a bleaching system. They comprise the bleaching system preferably in amounts from 0.1 to 40 wt.-%, more preferably in amounts from 0.5 to 30 wt.-% and particularly preferably in amounts from 3 to 25 wt.-%, in each case based on the total weight of the inventive automatic dishwashing detergent composition.

The bleaching system of the inventive automatic dishwashing detergent compositions comprises at least one bleaching agent c) and optionally at least one bleach catalyst d) and/or optionally at least one bleach activator e).

Bleaching agents c) may be compounds reacting with bleach activators e) and forming peroxyacids, which at low temperatures (e.g. at <70° C.) bleach much more effectively than the bleaching agents alone.

As an ingredient c) the inventive automatic dishwashing detergent compositions can contain an oxygen bleaching agent. Among the compounds that serve as bleaching agents and yield H₂O₂ in water, sodium percarbonate, sodium perborate tetrahydrate, and sodium perborate monohydrate are particularly significant. Other usable bleaching agents c) include peroxypyrophosphates, citrate perhydrates, and peracid salts or peracids that yield H₂O₂, such as perbenzoates, peroxophthalates, diperazelaic acid, phthaloimino peracid, or diperdodecanedioic acid. Organic bleaching agents c) can also be used. Typical organic bleaching agents c) are diacyl peroxides such as dibenzoylperoxide. Further typical organic bleaching agents c) are peroxy acids such as alkylperoxy acids and arylperoxy acids.

Preferred bleaching agents c) are inorganic peracids and/or their salts.

More preferred bleaching agents c) are inorganic perhydrate salts, most preferred perborate, percarbonate, perphosphate, persulfate and persilicate salts. Inorganic perhydrate salts are normally alkali metal salts. The inorganic perhydrate salt may be included as the crystalline solid without additional protection. Alternatively, the salt can be coated. Alkali metal percarbonates, particularly sodium percarbonate are preferred perhydrates for use herein. The percarbonate is most preferably incorporated into the products in a coated form which provides in-product stability. A suitable coating material providing in product stability comprises mixed salt of a water-soluble alkali metal sulphate and carbonate. Such coatings together with coating processes have previously been described in GB-A-1,466,799. The weight ratio of the mixed salt coating material to percarbonate lies in the range from 1:200 to 1:4, more preferably from 1:99 to 19, and most preferably from 1:49 to 1:19. Preferably, the mixed salt is of sodium sulphate and sodium carbonate which has the general formula Na₂SO₄.n.Na₂CO₃ wherein n is from 0.1 to 3, preferably n is from 0.3 to 1.0 and most preferably n is from 0.2 to 0.5.

Another suitable coating material providing in product stability, comprises sodium silicate of SiO₂:Na₂O ratio from 1.8:1 to 3.0:1, preferably 1.8:1 to 2.4:1, and/or sodium metasilicate, preferably applied at a level of from 2% to 10%, (normally from 3% to 5%) of SiO₂ by weight of the inorganic perhydrate salt. Magnesium silicate can also be included in the coating. Coatings that contain silicate and borate salts or boric acids or other inorganics are also suitable.

Other coatings which contain waxes, oils, fatty soaps can also be used advantageously within the present invention.

Potassium peroxymonopersulfate is another inorganic perhydrate salt of utility herein.

Particularly preferred inorganic bleaching agents c) are sodium perborate (monohydrate and tetrahydrate) and/or sodium percarbonate.

Among inorganic monoperoxysulfuric acid and its salts, preference is given in particular to potassium peroxymonosulfate (available under the trade name Caroat).

Preferred inventive automatic dishwashing detergent compositions contain, based on the total weight of the composition, from 1.0 to 20 wt.-%, preferably from 4.0 to 18 wt.-%, and more preferably from 8 to 15 wt.-% of a bleaching agent c), preferably sodium percarbonate.

As bleach activators e) the compositions according to the invention can comprise one or more substances selected from the following group: polyacylated alkylene-diamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyloxy- or n-lauroyloxybenzenesulfonate (NOBS or LOBS), acylated phenolcarboxylic acids, in particular nonanoyloxy- or decanoyloxybenzoic acid (NOBA or DOBA), carboxylic anhydrides, in particular phthalic anhydride, acylated polyhydric alcohols, in particular triacetin, ethylene glycol diacetate and 2,5-diacetoxy-2,5-dihydrofurane, and acylated sorbitol and mannitol, or mixtures thereof (SORMAN), acylated sugar derivatives, in particular pentaacetylglucose (PAG), pentaacetylfructose, tetraacetylxylose and octaacetyllactose, and acetylated, optionally N-alkylated glucamine and gluconolactone, and/or N-acylated lactams, for example N-benzoylcaprolactam. Hydrophilically substituted acylacetals and acyllactams are likewise preferably used. In addition, nitrile derivatives such as n-methylmorpholinium acetonitrile methylsulfate (MMA) or cyanomorpholine (MOR) can be used as bleach activators. Combinations of conventional bleach activators can also be used.

Particularly preferred bleach activators e) are tetraacetylethylenediamine, decanoyloxybenzoic acid, n-nonanoyloxybenzenesulfonate or n-lauroyloxybenzenesulfonate.

Bleach activators e), in particular TAED, are preferably used in quantities of up to 10 wt.-%, in particular from 0.1 to 8 wt.-%, particularly from 2 to 8 wt.-%, and particularly preferably from 2 to 6 wt.-%, based in each case on the total weight of the bleach activator e) containing inventive automatic dishwashing detergent composition.

Bleaching agents c) may be also other compounds acting without bleach. Suitable such bleaching agents c) are peracids or salts thereof.

Particularly preferred peracids or peracid salts are peroxycarboxylic acids and salts thereof of the formula

R—CO—O—O⁻X⁺

wherein R is an alkyl group, aralkyl group, cycloalkyl group, aryl group or heterocyclic group, preferably a linear or branched, substituted or unsubstituted alkyl group, particularly preferred an alkyl group having 6-9 carbon atoms, and X⁺ is a suitable counterion, preferably a H⁺, potassium or sodium ion. Especially preferred are peroxyhexanoylacid, peroxyheptanoylacid, peroxyoctanoylacid, peroxynonanoylacid, peroxydecanoylacid and their salts.

Furthermore, particularly preferred peracids or peracid salts are peroxy sulfonic acids and their salts according to the formula

R—S(O)₂—O—O⁻X⁺

wherein R is an alkyl group, aralkyl group, cycloalkyl group, aryl group or heterocyclic group, preferably a linear or branched, substituted or unsubstituted alkyl group, particularly preferred an alkyl group having 6-9 carbon atoms, and X⁺ is a suitable counterion, preferably a H⁺, a potassium or sodium ion.

Furthermore, particularly preferred peracids or peracid salts are peroxophthalic acids and salts thereof, phthalimino peracids and salts thereof, diperoxy carboxylic acids and salts thereof, or peroxysulphuric acids and salts thereof.

Among the bleaching agents c) that act without bleach activator e), especially the peracids or salts thereof are preferred, which are selected from the group consisting of monoperoxyphthalic acid and their salts, N,N-phthaloylaminoperoxycaproic acid (PAP) and their salts, diperazelaic acid and its salts, diperdodecanedioic acid and their salts, monoperoxy sulfuric acid and their salts, wherein the salts are preferably selected from the sodium and/or potassium salts. Among monoperoxy sulfuric acid and their salts in particular the potassium peroxymonosulphate (sold under the trade name Caroat®) is preferred.

In a further particularly preferred embodiment of the invention, the bleaching agent c) is N,N-phthaloylaminoperoxycaproic acid.

As an ingredient d) the inventive automatic dishwashing detergent compositions contain so-called bleach catalysts d). These components d) can be used in addition to or instead of conventional bleach activators.

As an ingredient d) the inventive automatic dishwashing detergent compositions may contain and preferably do contain so-called bleach catalysts. These components d) can be used in addition to or instead of conventional bleach activators e).

Suitable bleach catalysts d) are preferably bleach-boosting transition metal salts or complexes of manganese, iron, cobalt, ruthenium, molybdenum, titanium or vanadium.

These substances are preferably bleach-enhancing transition-metal salts or transition-metal complexes such as, for example, Mn, Fe, Co, Ru, or Mo salts or complexes, preferably carbonyl complexes. Mn, Fe, Co, Ru, Mo, Ti, V, and Cu complexes having nitrogen-containing tripod ligands, as well as Co, Fe, Cu, and Ru amine complexes, are also usable as bleach catalysts d).

Preferred bleaching catalysts d) are one or more manganese complex compounds of general formula (1)

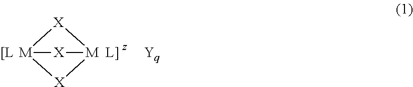

wherein
M independently of one another is selected from manganese in oxidation state III or IV,
X independently of one another is a coordinating or bridging species which is selected from the group H₂O, O₂²⁻—, O²⁻—, O₂⁺, OH⁺, HO²⁻—, SH—, S²⁻, SO, Cl⁻, N₃⁻, SCN⁻, N₃—, RCOO⁻, NH₂⁻ and NR₃, wherein R is a radical selected from hydrogen, alkyl, preferably C₁-C₄-alkyl, and aryl, preferably phenyl,
L independently of one another are organic ligands, comprising each at least two nitrogen atoms coordinating at manganese,
z is an integer between −4 and +4,
Y is a mono- or multivalent counterion selected from chloride, sulphate, hydrogensulphate, nitrate and acetate (OAc), acetylacetonate, oxalate, resulting in a charge neutrality of the complex, and
q is an integer from 1 to 4.

It is particularly preferred to use manganese complexes in oxidation states II, III, IV or V, preferably containing one or more macrocyclic ligand(s) having the donor functions N, NR, PR, O, and/or S. Ligands having nitrogen donor functions are preferred.

Preferred organic ligands L are at least nine-membered rings wherein at least two, preferably three or four ring nitrogen atoms are present and coordinate with the manganese. Examples of macromolecular ligands are: 1,4,7-triazacyclononane (TACN), 1,4,7-trimethyl-1,4,7-triazacyclononane (1,4,7-Me3-TACN), 1,5,9-triazacyclododecane (TACD), 1,5,9-trimethyl-1,5,9-triazacyclododecane (1,5,9-Me3-TACD), 1,4,7,10-tetrazacyclododecane (Cyclam), 1,4,7,10-tetramethyl-1,4,7,10-tetrazacyclododecane (1,4,7,10-Me4-Cyclam), 2-methyl-1,4,7-trimethyl-1,4,7-triazacylononane (2-Me-1,4,7-Me3-TACN), 2-methyl-1,4,7-triazacyclononane (2-Me-TACN) or 1,2-bis-(4,7,-dimethyl-1,4,7-triazacyclonon-1-yl)-ethane (Me4-DTNE). Especially preferred from this group are 1,4,7-trimethyl-1,4,7-triazacyclononane (1,4,7-Me3-TACN) and 1,2-bis-(4,7-dimethyl-1,4,7-triazacyclonon-1-yl)-ethane (Me4-DTNE). Most preferred is 1,4,7-trimethyl-1,4,7-triazacyclononane (1,4,7-Me3-TACN).

Suitable manganese complexes of general formula (1) include

### [Mn^{III}₂(μ-O)₁(μ-OAc)₂(TACN)₂](ClO₄)₂,

### [Mn^{III}Mn^{IV}(μ-O)₂(μ-OAc)₁(TACN)₂](BPh₄)₂,

### [Mn^{IV}₄(μ-O)₆(TACN)₄](ClO₄)₄,

### [Mn^{III}₂(μ-O)₁(μ-OAc)₂(Me-TACN)₂](ClO₄)₂,

### [Mn^{III}Mn^{IV}(μ-O)₁(μ-OAc)₂(Me-TACN)₂](ClO₄)₃,

### [Mn^{IV}₂ (μ-O)₃(Me-TACN)₂](PF₆)₂,

### [Mn^{IV}₂(μ-O)₃(Me/Me-TACN)₂](PF₆)₂(OAc═OC(O)CH₃),

### [Mn^{IV}₂(μ-O)₃(1,4,7-Me₃-TACN)₂](Cl)₂,

### [Mn^{IV}₂(μ-O)₃(1,4,7-Me₃-TACN)₂](SO₄),

### [Mn^{IV}₂(μ-O)₃(1,4,7-Me₃-TACN)₂](OAc)₂,

### [Mn^{IV}₂ (μ-O)(μ-OAc)₂(1,4,7-Me₃-TACN)₂](OAc)₂, and

### [Mn^{IV}Mn^{III}(μ-O)₃(Me4-DTNE)](SO₄).

Among these compounds [Mn^{IV}₂(μ-O)₃(1,4,7-Me3-TACN)₂](Cl)₂, (tri-μ-oxo-bis[(1,4,7-trimethyl-1,4,7-triazacyclononane)-manganese-(IV)]-dichloride) and [Mn^{IV}₂(μ-O)₃(1,4,7-Me3-TACN)₂](SO₄) and (tri-μ-oxo-bis[(1,4,7-trimethyl-1,4,7-triazacyclononane)-manganese(IV)]-sulfate) are especially preferred.

In a further preferred embodiment of the invention the inventive automatic dishwashing detergent compositions contain a bleach catalyst d) chosen from bleach-enhancing transition-metal salts and transition-metal complexes, preferably from manganese complexes with 1,4,7-trimethyl-1,4,7-triazacyclononane (Me-TACN) or 1,2,4,7-tetramethyl-1,4,7-triazacyclononane (Me4-TACN), since cleaning results can be significantly improved with these bleach catalysts.

Preferred bleach catalysts d) for use herein include the manganese triazacyclononane and related complexes (U.S. Pat. No. 4,246,612, U.S. Pat. No. 5,227,084); Co, Cu, Mn and Fe bispyridyl-amine and related complexes (U.S. Pat. No. 5,114,611); and pentamine acetate cobalt(III) and related complexes (U.S. Pat. No. 4,810,410).

A bleach catalyst d) is typically present in a level of from 0.01 to 10%, preferably from 0.5 to 2% by weight, based on the total weight of the composition.

The bleaching system comprises one or more bleaching agents c) and optionally one or more bleach catalysts d) and/or optionally one or more bleach activators e). Particularly preferably the bleaching system comprises one or more bleaching agents c) and one or more bleach activators d). Most preferably the bleaching system comprises one or more bleaching agents c) and one or more bleach activators d) and one or more bleach catalysts e).

The inventive compositions may comprise other ingredients commonly used in automatic dishwashing detergent compositions. In a further preferred embodiment of the invention the inventive automatic dishwashing detergent compositions comprise one or more compounds selected from the group consisting of enzymes, glass corrosion inhibitors, water, organic solvents, thickening agents, further surfactants (but no nonionic surfactants), suds suppressors, color speckles, silvercare, anti-tarnish and/or anti-corrosion agents, dyes, fillers, germicides, hydrotropes, anti-oxidants, enzyme stabilizing agents, perfumes, solubilizing agents, carriers, processing aids, pigments, and pH control agents.

In order to increase cleaning performance, inventive automatic dishwashing detergent compositions can also contain enzymes. These include proteases, amylases, lipases, hemicellulases, cellulases, perhydrolases, or oxidoreductases, as well as preferably mixtures thereof. These enzymes are, in principle, of natural origin. Improved variants based on the natural molecules are available for use in automatic dishwashing detergent compositions and are correspondingly preferred for use. Inventive automatic dishwashing detergent compositions contain enzymes preferably in amounts from 1×10⁻⁶ to 5 wt.-%, based on active protein and furthermore based on the total weight of the inventive automatic dishwashing detergent compositions. Protein concentration can be determined by known processes such as the BCA process or biuret process.

A protein and/or enzyme can be protected, especially during storage, from damage such as inactivation, denaturing, or decomposition (e.g. resulting from physical influences, oxidation, or proteolytic cleavage). Inhibition of proteolysis is particularly preferred in microbial recovery of proteins and/or enzymes, particularly when the inventive automatic dishwashing detergent compositions also contain proteases. Inventive automatic dishwashing detergent compositions can contain stabilizers for this purpose; the provision of such agents in inventive automatic dishwashing detergent compositions represents a preferred embodiment of the present invention.

Those inventive automatic dishwashing detergent compositions containing, based on the total weight of the composition, from 0.1 to 12 wt.-%, by preference from 0.2 to 10 wt.-%, and in particular from 0.5 to 8 wt.-% of enzyme preparation, are particularly preferred.

Glass corrosion inhibitors are further preferred ingredients of inventive automatic dishwashing detergent compositions. Glass corrosion inhibitors prevent the occurrence of clouding, smearing, and scratches, as well as iridescence, on the glass surface of automatically cleaned glassware. Preferred glass corrosion inhibitors include magnesium and zinc salts and magnesium and zinc complexes.

Inventive automatic dishwashing detergent compositions can be prepared in solid or liquid form, as well as a combination of solid and liquid presentation forms.

Because elevated alkalinity of the inventive automatic dishwashing detergent compositions contributes to the cleaning performance of these compositions, but also to the corrosive and irritating effect of these compositions, preferred inventive automatic dishwashing detergent compositions have a pH at 20° C. from 8 to 14, preferably from 9 to 11.5, and more preferably from 9.5 to 11.5, measured as a solution of 10 wt.-% of the liquid or solid inventive automatic dishwashing detergent composition in water.

Cleaning performance of inventive automatic dishwashing detergent compositions can be improved by addition of organic solvents. A preferred embodiment of the present invention is therefore automatic dishwashing detergent compositions that contain at least one organic solvent. Preferred liquid inventive automatic dishwashing detergent compositions contain, based on the total weight of the composition, organic solvent in quantities from 0.2 to 15 wt.-%, by preference from 0.5 to 12 wt.-%, and particularly preferably from 1.0 to 10 wt.-%.

These organic solvents derive, for example, from monoalcohols, diols, triols or polyols, the ethers, esters, and/or amides. Organic solvents that are water-soluble are particularly preferred in this context, “water-soluble” solvents for purposes of the present application being solvents that are completely miscible with water (i.e. with no miscibility gap) at room temperature.

Organic solvents from organic amines and/or alkanolamines are effective in cleaning performance, and particularly with regard to cleaning performance on bleachable stains, in particular on tea stains.

In order to achieve the desired viscosity for liquid inventive automatic dishwashing detergent compositions, thickening agents can be added thereto. Thickening agents commonly used in automatic dishwashing detergent compositions can also be used in the inventive compositions.

It is advantageous if the respective liquid inventive automatic dishwashing detergent compositions contain the thickening agent in quantities preferably from 0.1 to 8 wt.-%, more preferably from 0.2 to 6 wt.-%, and particularly preferably from 0.4 to 4 wt.-%, based on the total weight of the inventive automatic dishwashing detergent composition.

The surfactants may be chosen from either zwitterionic surfactants, anionic surfactants or mixtures thereof.

The zwitterionic surfactant preferably is chosen from the group consisting of C₈ to C₁₈ (preferably C₁₂ to C₁₈) amine oxides and sulfo and hydroxy betaines, such as N-alkyl-N,N-dimethylamino-1-propane sulfonate where the alkyl group can be C₉ to C₁₈, preferably C₁₀ to C₁₄.

The anionic surfactant preferably is chosen from alkylethoxysulfates, with the degree of ethoxylation greater than 3 (preferably 4 to 10; more preferably 6 to 8), and chain length in the range of C₈ to C₁₆, preferably C₁₁ to C₁₅. Additionally, branched alkylcarboxylates have been found to be useful for the purpose of the present invention when the branch occurs in the middle and the average total chain length is 10 to 18, preferably 12 to 16 with the side branch 2 to 4 carbons in length. An example is 2-butyloctanoic acid. The anionic surfactant is typically of a type having good solubility in the presence of calcium. Such anionic surfactants are further illustrated by sulfobetaines, alkyl(polyethoxy) sulfates (AES), and short chained C₆-C₁₀ alkyl sulfates and sulfonates. Straight chain fatty acids have been shown to be ineffective due to their sensitivity to calcium.

In a further preferred embodiment of the present invention, the inventive automatic dishwashing detergent compositions do not comprise other surfactants in addition to the one or more compounds of the formula (I).

The suds suppressors, color speckles, silvercare, anti-tarnish and/or anti-corrosion agents, dyes, fillers, germicides, hydrotropes, anti-oxidants, enzyme stabilizing agents, perfumes, solubilizing agents, carriers, processing aids, pigments, and pH control agents can be chosen from the respective substances commonly used in automatic dishwashing detergent compositions.

In a further preferred embodiment of the invention the inventive automatic dishwashing detergent compositions do not comprise phosphates, i.e. they are phosphate-free.

In a further preferred embodiment of the invention the inventive automatic dishwashing detergent compositions are liquid at 20° C. Liquid presentation forms, preferably based on water and/or organic solvents, can exist in thickened form as gels. Preferably, the inventive liquid compositions comprise up to 60 wt.-% of water, more preferably from 10 to 60 wt.-% of water and even more preferably from 25 to 60 wt.-% of water, in each case based on the total weight of the inventive liquid automatic dishwashing detergent composition. This liquid composition can be provided in the form of a liquid, paste, cream or gel and can be optionally encapsulated, packaged in a single- or multi-compartment pouch, or absorbed onto a porous carrier material.

In a further preferred embodiment of the invention the inventive automatic dishwashing detergent compositions are solid at 20° C. Powders, granulates, extrudates, or compactates, particularly tablets, are especially suitable as solid presentation forms. Preferably, the inventive solid compositions comprise less than 20 wt.-% of water, more preferably from 0.1 to 20 wt.-% of water and even more preferably from 0.5 to 5 wt.-% of water, in each case based on the total weight of the inventive solid automatic dishwashing detergent composition. In another preferred embodiment of the invention the inventive automatic dishwashing detergent compositions are water-free.

In a still further preferred embodiment of the invention the inventive automatic dishwashing detergent compositions are provided in an all-in-one dosing system, preferably in a mono- or multi-compartment pouch made from a water-soluble film, for example a film comprising polyvinyl alcohol, or a tablet containing all ingredients of the composition. The automatic dishwashing detergent compositions may be provided as multiphase detergent compositions delivering separate portions thereof into the same cycle or into different cycles of an automatic dishwashing machine. The multiphase detergent composition, for example, could take the form of a multi-layer liquid (e.g. coacervate) or of a gel contained in a bottle, or of a multiphase tablet incorporating a liquid composition in the form of a gel contained within a preformed cavity or recess within the main tablet body.

Using the inventive automatic dishwashing detergent compositions results in a decrease of the hardness of the water used for the dishwashing process. The hardness of water is determined by the concentration of multivalent cations in the water. Usually, the cations have the charge +2. Common cations found in hard water include Ca²⁺ and Mg²⁺. With hard water, soap solutions form a white precipitate instead of producing lather. This effect arises because the 2+ ions destroy the surfactant properties of the soap by forming a solid precipitate. Hardness can be quantified by instrumental analysis. The total water hardness in terms of this specification is the sum of the molar concentrations of Ca²⁺ and Mg²⁺, in mol/L units. Water hardness is often not expressed as a molar concentration, but rather in various units, such as German degrees (°dH). The various alternative units represent an equivalent mass of calcium oxide (CaO) or calcium carbonate (CaCO₃) that, when dissolved in a unit volume of pure water, would result in the same total molar concentration of Mg²⁺ and Ca²⁺. 1°dH is formally defined as 10 mg CaO per 1 Liter water.

In a further preferred embodiment of the invention the inventive automatic dishwashing detergent compositions reduce the hardness of the water used in the dishwashing process to a hardness between 1 and 13°dH, preferably to a hardness between 4 and 12°dH, and most preferred to a hardness between 6 and 10°dH.

The inventive automatic dishwashing detergent compositions are advantageously suited for washing tableware in automatic dishwashing machines, whereby soiled tableware is treated in an automatic dishwashing machine with an aqueous alkaline composition comprising an inventive automatic dishwashing detergent composition.

Therefore, the present invention also provides a method of washing tableware in an automatic dishwashing machine, comprising treating soiled tableware in an automatic dishwashing machine with an aqueous alkaline composition comprising an inventive automatic dishwashing detergent composition.

In the inventive method of washing tableware the pH value of the aqueous alkaline composition preferably is 8 or higher and more preferably 9 or higher.

The examples below are intended to illustrate the invention in detail without, however, limiting it thereto. Unless explicitly stated otherwise, all of the percentages are percentages by weight (% by wt. or wt.-%).

### EXAMPLES

### Dishwashing Detergent Performance Test (Spotting)

| | |
|---|---|
| dishwasher: | Miele G 1222 SC GSL |
| items to test spotting: | new items are all pre-treated with demineralized |
| | water in Normal eco program of a Bosch logixx |
| | dishwasher using 5 times the cleaner combination |
| | to be tested, then once 20 g of citric acid, finally |
| | once pure water |
| in the upper rack: | 8 Hibal Schott “Paris” on the left and on the right |
| in the lower rack: | 3 black porcelain plates |
| | 3 square black glass plates |
| | 8 blue melamine plates |
| in cutlery drawer with | 8 knives “solid” by WMF |
| handles to the middle | |
| OR in cutlery basket | |
| with handles down: | |
| dishwasher program: | no. 2 “short” (=R 0): |
| | with pre-wash, |
| | main wash at 55° C., |
| | rinse cycle at 65° C. |
| amount of water: | 4.6 to 4.8 liter per each of the 4 water-intakes for |
| | pre-wash, main wash, intermediate rinse and final |
| | rinse |
| water hardness: | 14 °dH (tap water) |
| water softening: | none |
| cleaner dosage: | 20 g of a powder cleaner or 1 tab, respectively, in |
| | the dosing chamber |
| soil: | a bottle top down with 50 g of frozen modified |
| | Stiwa soil added immediately after the dosage |
| | chamber opened (i.e. 14 minutes after program |
| | start) |
| rinse-aid: | none |
| number of cleaning | 3 |
| cycles: | |
| time to cool down: | 10 minutes with closed door, then the door is |
| | opened and the racks are drawn out completely |
| evaluation: | 30 minutes later when the test items are dry and |
| | cold |
| rating: | 8: no spots or streaks to |
| | 0: very numerous large spots and/or streaks |
| | filming is only mentioned when it is so serious |
| | that the spots are not to be seen |
| after the test: | machine is cleaned once with 20 g of citric acid, |
| | once with pure water in the test program |

### Preparation of Soils and Soil Composition:

### Recipe for the Preparation of 5 kg of Soil:

| | | | |
|---|---|---|---|
| A | margarine | 500 | g |
| B | gravy powder (Maggi) | 125 | g |
| | potato starch | 25 | g |
| | benzoic acid | 5 | g |
| C | yolk size M | 15 | g |
| | mustard (Streuber) | 125 | g |
| | ketchup (Heinz) | 125 | g |
| | milk with 1.5% fat | 250 | g |
| D | tap water | 3.50 | liter |

I A is melted in a 1 liter-beaker with the microwave at 600 W for 5 minutes.
II The components of B are added one after another to I by mixing well with a hand-held blender.
III The components of C are added one after another into a 10 liter-pail and blended well with the blender.
IV When II is lukewarm, it is added to III by mixing thoroughly.
V Then the water is stirred into IV in steps of about 0.5 to 1 liter, and the mixture is homogenized.
VI The soil is weighed by 50 g into square 100 ml-jars. In between it is mixed up with the blender.

### Evaluation of Results—Visual Grading:

8: free of spots and stripes
7: few very thin stripes and/or few very small spots
6: few thin stripes and/or some small spots
5: thin to medium stripes and/or few medium sized spots and/or numerous small spots
4: few medium stripes and/or some medium sized spots
3: medium stripes and/or few large spots and/or numerous medium sized spots
2: few broad stripes and/or some large spots and/or very numerous medium sized spots
1: broad stripes and/or numerous large spots
0: very large stripes and/or very numerous large spots

The single gradings for each test item are added together and the sum is used to compare the different detergent compositions.

### Composition of the Tested Automatic Dishwashing Detergent Compositions

| | | % by |
|---|---|---|
| Component | Chemical name | wt. a.i. |
| Sodium disilicate amorphous | | 20.0 |
| Soda ash (heavy) | Sodium carbonate | 15.0 |
| Trisodium citrate dihydrate | | 25.0 |
| Trilon ® M Powder (BASF) | Trisodium salt of | 15.0 |
| | methylglycinediacetic acid | |
| Sokalan ® PA 30 CL (BASF) | Acrylic acid, homopolymer | 5.0 |
| Sodium percarbonate | | 11.0 |
| (tri-μ-oxo-bis[(1,4,7-trimethyl- | | 1.0 |
| 1,4,7-triazacyclononane)- | | |
| manganese-(IV)]-dichloride) | | |
| Peractive ® AC (Clariant) | Tetraacetyl ethylenediamine | 2.5 |
| Savinase 8.0 T (Novozymes) | | 1.0*⁾ |
| Termamyl 120 T (Novozymes) | | 1.0*⁾ |
| Surfactant system | | 3.5 |

a.i.: active ingredient
*⁾the amount in wt.-% is not related to the active ingredient but to the product as is

### Example 1

### Surfactant System

| | |
|---|---|
| Alkyloxydiethoxy-/Alkenyloxydiethoxy acetic acid¹⁾ | 100% by wt |
| (alkyloxy component derived from cetyl alcohol as main | |
| component and alkenyloxy component derived from | |
| oleyl alcohol as main component) | |

¹⁾chloride content 1% by weight, determined by ion exchange chromatography

### Comparative Example

### Surfactant System

| | |
|---|---|
| Alkyloxydiethoxy-/Alkenyloxydiethoxy acetic acid¹⁾ | 40% by wt. |
| (alkyloxy component derived from cetyl alcohol as main | |
| component and alkenyloxy component derived from | |
| oleyl alcohol as main component) | |
| nonionic surfactant with cloud point 18° C. (1% by wt. in | 60% by wt. |
| water), (1,2 epoxydodecane capped C_{8/10} alcohol + 40 EO) | |

¹⁾chloride content 1% by weight, determined by ion exchange chromatography

The values for the total result spotting using the compositions of Example 1 and of the Comparative Example are given in the following Table A.

TABLE A
Values for the total result spotting

| | Total result spotting [points] |
|---|---|
| Composition | (maximum: 240 points) |
| Example 1 | 132 |
| Comparative Example | 105 |

From the results of Table A above one can see that the use of the inventive composition of Example 1 results in better values for the total result spotting compared to the use of the composition according to the Comparative Example.

Furthermore, in the above example the inventive composition of Example 1 shows a very good overall cleaning performance.

1. An automatic dishwashing detergent composition comprising
a) at least one compound of the formula (I)
RO—(CH₂CH₂O—)ₙCH₂—COOM (I),
wherein
R is a linear or branched saturated alkyl group comprising from 8 to 30 carbon atoms or a linear or branched unsaturated alkenyl group with one or more double bonds and comprising from 8 to 30 carbon atoms,
n is a number from 1 to 20, and
M is a counter ion,
b) at least one er-mere-builder substance, and
c) at least one er-mere-bleaching agent, wherein
the automatic dishwashing detergent compositions contain no chloride ions or wherein the total amount of chloride ions in the automatic dishwashing detergent compositions is below 0.5% by weight, referring to the total composition, and wherein the automatic dishwashing detergent composition is free of nonionic surfactant.

2. The automatic dishwashing detergent composition according to claim 1, wherein the composition further contains at least one bleaching catalyst d).

3. The automatic dishwashing detergent composition according to claim 1, wherein the counter ion M in the at least one compound of the formula (I) is selected from the group consisting of H⁺, Na⁺, K⁺, Mg²⁺/2, Ca²⁺/2, NH₄⁺, monoethanolammonium, diethanolammonium and triethanolammonium.

4. The automatic dishwashing detergent composition according to claim 3, wherein the counter ion M in the at least one compound of the formula (I) is selected from the group consisting of H⁺, Na⁺ and K⁺.

5. The automatic dishwashing detergent composition according to claim 1, wherein R in the at least one compound of the formula (I) is a linear or branched saturated alkyl group comprising from 12 to 18 carbon atoms or a linear or branched unsaturated alkenyl group with one or more double bonds and comprising from 12 to 18 carbon atoms.

6. The automatic dishwashing detergent composition according to claim 5, wherein R in the at least one compound of the formula (I) is a linear or branched saturated alkyl group comprising from 16 to 18 carbon atoms or a linear or branched unsaturated alkenyl group with one or more double bonds and comprising from 16 to 18 carbon atoms.

7. The automatic dishwashing detergent composition according to claim 1, wherein the at least one compound of the formula (I) 50 wt.-% or more of the groups R are linear or branched unsaturated alkenyl groups with at least one double bond.

8. The automatic dishwashing detergent composition according to claim 1, wherein R in the at least one compound of the formula (I) is a linear group.

9. The automatic dishwashing detergent composition according to claim 1, wherein R in the at least one compound of the formula (I) is a mixture comprising oleyl groups and cetyl groups.

10. The automatic dishwashing detergent composition according to claim 1, wherein n in the at least one compound of the formula (I) is a number from 1 to 3.

11. The automatic dishwashing detergent composition according to claim 10, wherein n in the at least one of the formula (I) is 2.

12. The automatic dishwashing detergent composition according to claim 1, wherein the composition has a chloride content of between 0 to 0.05% by weight, referring to the total composition.

13. The automatic dishwashing detergent composition according to claim 1, wherein it comprises the at least one compound of the formula (I) in amounts from 0.1 to 15 wt.-%, based on the total weight of the automatic dishwashing detergent composition.

14. The automatic dishwashing detergent composition according to claim 1, wherein it comprises the at least one or builder substance b) in amounts from 5 to 90 wt.-%, based on the total weight of the automatic dishwashing detergent composition.

15. The automatic dishwashing detergent composition according to claim 1, wherein comprises inorganic peracids and/or their salts as bleaching agent c).

16. The automatic dishwashing detergent composition according to claim 1, wherein it comprises, based on the total weight of the composition, from 1.0 to 20 wt.-% of the bleaching agent c).

17. The automatic dishwashing detergent composition according to claim 1, wherein it comprises Mn, Fe, Co, Ru, or Mo salts or complexes as bleach catalyst d).

18. The automatic dishwashing detergent composition according to claim 2, wherein it comprises, based on the total weight of the composition, from 0.01 to 10% by weight, of the bleach catalyst d).

19. The automatic dishwashing detergent composition according to claim 15, wherein it comprises a bleaching system in amounts from 0.1 to 40 wt.-%, based on the total weight of the automatic dishwashing detergent composition, wherein the bleaching system comprises at least one bleaching agent c) and at least one bleach catalyst d).

20. The automatic dishwashing detergent composition according to claim 1, wherein it further comprises at least one compound selected from the group consisting of enzymes, glass corrosion inhibitors, water, organic solvents, thickening agents, surfactants (but no nonionic surfactants), suds suppressors, color speckles, silvercare, anti-tarnish and/or anti-corrosion agents, dyes, fillers, germicides, hydrotropes, anti-oxidants, enzyme stabilizing agents, perfumes, solubilizing agents, carriers, processing aids, pigments, and pH control agents.

21. The automatic dishwashing detergent composition according to claim 1, wherein it does not comprise other surfactants in addition to the at least one compound of the formula (I).

22. The automatic dishwashing detergent composition according to claim 1, wherein it is provided in an all-in-one dosing system, or as a tablet containing all ingredients of the composition, or as a multiphase detergent composition delivering separate portions thereof into the same cycle or into different cycles of an automatic dishwashing machine.

23. The automatic dishwashing detergent composition according to claim 1, wherein it reduces the hardness of the water used in the dishwashing process to a hardness between 1 and 13°dH.

24. A method of washing tableware in an automatic dishwashing machine, comprising treating soiled tableware in an automatic dishwashing machine with an aqueous alkaline composition comprising an automatic dishwashing detergent composition according to claim 1.

25. The method according to claim 24, wherein the pH value of the aqueous alkaline composition is 8 or higher.
